(19) United States
(12) Patent Application Publication
(10) Pub. No.: US 2012/0325159 A1
(43) Pub. Date: Dec. 27, 2012

(54) Pet waste box

(76) Inventor: Ronald Penner, Hampton, VA (US)

(21) Appl. No.: 13/135,025

(22) Filed: Jun. 22, 2011

(51) Int. Cl. A01K 1/01; A01K 29/00

(52) U.S. Cl. 119/166

(57) ABSTRACT

A cat litter box assembly includes a plurality of stackable pans having sloped sides and a filtering mechanism for sifting pet waste from clean litter. The filtering mechanism includes a grate having offset openings in a bottom and side of each pan. The openings are staggered such that openings in an upper pan are on an opposite side from openings in a lower pan to ensure a solid structure which maintains both pet waste and litter therein.

There are no related patent applications.

The present application was not subject to federal research and/or development funding.

### TECHNICAL FIELD

Generally, the present invention relates to a pet waste box assembly comprising a plurality of uniformly-shaped stackable boxes which are used in sequential order to clean pet waste. More specifically, the invention is a pet waste box assembly that is useful in containment and removal of cat litter and waste. Each stackable box includes an open top, tapered sides, and openings or grates in the bottom. During use, the user stacks the boxes such that the grates are arranged in an alternating manner. That is, the grates are alternated such that a solid bottom is arranged below the grates of each box except the bottom one. Litter is deposited into the top box with the grates in the top box being sealed by a solid portion of the next succeeding box. To use, the user simply picks up the top box and easily separates the pet waste from unused litter by shaking the top box in a back-and-forth or side-to-side manner to cause the unused litter to fall through the grates into the box below. Waste is maintained within the top box which is then dumped into an appropriate waste receptacle. The top box is then positioned beneath the plurality of stacked boxes.

### BACKGROUND OF THE INVENTION

Keeping pets is a never-ending task, requiring one to constantly feed the pets and clean their waste. For those that raise, breed, or board cats, their responsibilities also include maintaining a litter box. Such maintenance ensures that the cat is provided a healthy and sanitary location for its excrement. This maintenance includes periodic cleaning and changing of the litter in the litter box. Typically, the cat owner must sift through the litter to remove the solid clumps of urine and solid waste products with a handheld scoop. However, the scooping device often breaks up the clumps so that they are difficult to remove, thus causing waste material to remain in the sifted litter. Such waste material causes odors and unsanitary conditions. When sifting waste products from a cat box, the pet owner must sift through the entire amount of litter in the cat box to ensure that all waste is removed. This is time consuming and may be difficult for the elderly or disabled to perform on a repeating periodic basis. Moreover, it is often easy to lose track of when the litter should be replaced entirely. Accordingly, there exists a need for a means by which cat litter boxes can be more easily cleaned and maintained without the disadvantages as mentioned above. The development of the instant invention fulfills this need.

There are several different types of litter boxes. By way of example, the following patents are representative of the state of the art.

U.S. Pat. No. 3,796,188 to Bradstreet discloses a reusable, sanitary pet lavatory comprising a pair of identical nested box-like receptacles with each of the receptacles having a screened or perforated plate positioned above a slideable floor member. In use, the upper receptacle, which contains pet litter, nests within and is supported by the lower receptacle; the floor members located in each receptacle being in a closed position with respect to the perforated plate. The closed floor member in the upper receptacle prevents the pet litter, in which pet excrement is deposited, from falling into the lower receptacle until separation of the excrement from the litter is desired. The apertures perforated in the plate member are sized to screen out the solid pet excrement while permitting the separated pet litter to pass through to the lower receptacle for collection when the slide in the upper receptacle is opened. The components are interchangeable so that each receptacle can serve as either the separating or collecting means for the lavatory.

U.S. Pat. No. 3,809,013 to Rigney et al. discloses an insert for placement in an open, self-supporting tray for use as an animal litter box. A number of disposable screens are stacked on top of each other, constructed of flat, thin flexible material such as paper or plastic film, include a plurality of holes at their center portion and are placed in the tray so that walls of the tray fold the screens into a receptacle. Means is provided for closing the holes in the screens to prevent articles from entering the holes and for opening them upon lifting a screen from the stack. To change the liner and dispose of waste, the top liner is lifted whereby litter sifts through the holes onto the remaining screens for reuse while the liner and the waste thereon are discarded.

U.S. Pat. No. 3,908,597 to Taylor discloses a litter box for pets which has a central receptacle divided by a partition into dual compartments that may alternately serve as upper and lower litter areas. The receptacle ends have identical covers and a pair of screened trays are positioned within the chambers. The partition is removably retained within the receptacle which has a side wall portion formed with an entrance slot. To switch or change the litter areas, the partition may be selectively withdrawn from the receptacle through the slot. Absorbent material is then permitted to fall from the upper chamber to the lower chamber as litter waste from the pet is retained on the upper screened tray. Thereafter the upper screened tray is emptied and returned and the partition is inserted back through the entrance slot. The entire litter box is inverted or flipped over so that the other screened tray, previously on the bottom but now on the top of the partition, may be used for the litter area.

U.S. Pat. No. 4,217,857 to Geddie discloses an improved pet relief station for the receiving of pet excrement. The relief station comprises a screen pan having a screen portion, and a pair of receiving pans that are alternatively stackable one in the other. The screen pan is placed in one of the receiving pans, and this pan is in turn stacked in the other receiving pan. Pet litter is disposed in the screen pan to cover the screen portion thereof. Once pet solids have been deposited on the pet litter, the solids are removed by lifting the screen pan, sifting the pet litter which separates the pet solids onto the screen portion, and disposing of the solids. Immediate reassembly of the relief station is afforded by separating the receiving pans, positioning the screen pan in the empty receiving pan, and then pouring the litter over the screen portion of the screen pan. The receiving pans are then restacked.

U.S. Pat. No. 4,505,226 to Carlson discloses a litter-cleaning animal litter box which is comprised of two substantially identical nestably stacked animal litter receptacles, with aperture means at their bottoms sized to permit the passage of litter but retain solid waste. A false bottom, to which wetted litter adheres, is fitted into each receptacle. Litter is placed into the upper receptacle-false bottom combination. A retaining edge that keeps the cat from scratching litter from the box when instinctively digging and covering is press fitted onto the peripheral shoulder of the upper receptacle. The upper receptacle-false bottom combination serves as a litter and waste holding means. The lower receptacle-false bottom combination serves as a strained litter receiving means. When operated, the retaining edge is removed and set aside. The false bottom in the upper receptacle is removed along with the adhering wetted litter. The false bottom is vibrated, scraped, wiped, washed, or otherwise mechanically worked in order to remove the adhering litter for disposal. The upper receptacle is then moved back and forth, and to and fro to make the litter fall through the receptacle's aperture means into the lower receptacle-false bottom combination. Solid waste is retained in the upper receptacle and discarded. The cleaned false bottom is replaced into the cleaned receptacle. The receptacle-false bottom combination now containing the cleaned litter is nestably stacked into the reassembled just-cleaned combination. The retaining edge is pressed onto the peripheral shoulder of the now upper receptacle, litter added to replace that discarded during cleaning, and the litter-cleaning animal litter box is again ready for service.

U.S. Pat. No. 5,325,815 to Gumpesberger discloses a device for sifting a siftable material and which comprises at least three nestable trays. The trays are stacked to form a vertically stacked array. Each tray has a base having a plurality of ribs defining a plurality of openings sized to permit the material to pass through, while preventing passage of large objects. The openings of each tray are arranged in a pre-set pattern so that pairs of trays may be nested together with the openings of one tray blocked by the ribs of the other. The trays may be identical with the openings arranged asymmetrically in the base of each tray, so that the necessary interference or blocking is achieved by rotating each tray relative to the adjacent tray. Alternatively, the openings can be symmetrically located with two different trays being provided, having complementary patterns of openings. The stacked array of trays can be configured as a cat litter container, or used for sifting a variety of the material.

U.S. Pat. No. 5,517,947 to Christman discloses a sifting litter-box utilizing two identical litter trays (8a,8b), each with sieve openings (26a,26b) integrated into one sidewall (18a,18b). The trays are nested so that their respective integrated sieve openings (26a,26b) are on diametrically opposed sides of the nested pair of trays, thereby the backwall (22b) of the lower tray (8b) closes off the sieve openings (26a) of the upper tray (8a) when nested one atop the other. The litter (34) occupying only the top tray (8a) is, after use, sifted into the bottom tray (8b) by lifting the top tray (8a) and tilting its contents toward its sieve-wall (18a) allowing the reusable litter to pass through its sieve openings (26a) and form a static pile of sifted reusable litter (34) at the backwall (22b) of the bottom tray (8b). Feces and urine clumps (38) are retained in the top tray (8a) which in then emptied. The emptied top tray (8a) is sanitized and is nested as the bottom tray (8b), with the former bottom tray (8b) with the reusable litter pile becoming the top tray (8a) and once again the sieve-wall (18a) of the upper tray (8a) is closed off by the backwall (22b) of the lower tray (8b). The nested tray array is then shaken to level the sifted litter pile readying the sifting litter-box for reuse.

U.S. Pat. No. 5,799,610 to Poulos discloses a litter box assembly for pets that includes two identical, stackable litter boxes each having a bottom with a pattern of openings and pointed, raised projections. A track extends around the bottom of each box to hold a plate with defines mating apertures and slides back and forth in the track to, respectively, align the openings and close off the openings. A handle on each box attaches to the plate and may be moved to the open position to allow unclumped litter to flow into the box stacked below. The clumped waste is held off the bottom of the box on the raised projections for disposal by dumping. The lower box containing the filtered litter is moved to the top position of the stack to be ready for use.

U.S. Pat. No. 6,745,719 to Howerton discloses a litter sifting device for use with an existing litter box. The device has a first screen assembly and a second screen assembly, each having a screen, two handles, and two side walls. The screen has a mesh size which is small enough to permit unused litter to fall back into the litter box, while retaining soiled litter, when the device is removed from the litter box for appropriate disposal of the waste material. For smaller litter boxes, the first screen assembly may be used alone. For larger litter boxes, the second screen assembly may be used in conjunction with the first screen assembly. The first screen assembly is telescopically positionable within the second screen assembly, thereby allowing a range of possible lengths for the litter sifting device. The handles permit lifting the litter sifting device from the litter box without a user coming into contact with the soiled litter.

### SUMMARY OF THE INVENTION

A pet waste box assembly comprises a plurality of uniformly-shaped stackable boxes. Each box includes a plurality of openings that are sealed with a box arranged beneath and having a visual indicator that indicates which side the openings are arranged on. The plurality of boxes is used in sequential order to clean pet waste. The plurality of openings comprises a sifting grate that is located along an outer end of each box and off center. The boxes are arranged such that the sifting grates are staggered on an alternating basis so that litter is retained within the stack of boxes. The system is initiated with all of the boxes stacked together and a volume of cat litter provided in the topmost box. To clean the litter, the user lifts the uppermost box and sifts the unused, un-clumped litter through the sifting grate into the next box while retaining pet waste therein. Clumps of pet waste are discarded and the removed box is placed back on the bottom of the stack. That is, the boxes are designed to be used in sequential order to provide a clean litter box.

The invention provides a series of three, or even four, stackable boxes with each box being provided with tapered sides for stacking. The sifting grate is located along one outer end of each insert on an alternating basis to aid in the retention of litter at each level and may extend into a sidewall. Additionally, each tray may be color coded to aid in proper assembly or include a mark (visual indicator) on an upper edge for easily determining the position of the grate. One begins using the invention with all of the inserts stacked together with a volume of cat litter provided on the top within the uppermost box. To clean the litter box, one simply lifts the uppermost box to allow the clean litter to fall through and solid clumps to remain within the removed box. This method allows the clumps to remain intact so that they can be easily discarded in a typical matter and the removed box is simply placed back on the bottom of the litter box stack. The user can repeat this process an unlimited number of times. The litter can be completely replaced as needed. The use of the litter box sifting assembly provides cat owners an easy method to maintain a litter box without the usual mess associated with such devices.

It is an object of the invention to provide a cat litter box system that provides easy cleaning and maintenance while minimizing a cleanup time. Such ease in cleaning and maintaining the cat litter box system is both healthier for the pet and the pet owner. Moreover, the ease in cleaning the litter box increases the likelihood of removal of pet waste.

It is further object of the invention to provide a plurality of stackable boxes having openings in the bottom for sifting pet waste from unused litter. Such openings are offset and provide a superior pet waste cleaning device that reduces the mess of cleaning soiled litter.

It is an additional object of the invention to provide a plurality of trays, each including at least one visual indicator that indicates a location of a sifting mechanism relative to a centerline that bisects the trays.

It is a further object of the invention to teach a stackable array of boxes each having a tapered edge for ease in separating individual boxes from the remaining stack of boxes.

It is an additional object of the invention to teach a stackable array of boxes that reduces the amount of time spent cleaning pet litter.

Additional objects and advantages of the invention will be set forth in part in the description which follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1 is an exploded perspective view of a first embodiment of the tray assembly.

FIG. 2 is an exploded perspective view of a second embodiment of the tray assembly.

FIG. 3 is an exploded perspective view of a third embodiment of the tray assembly.

FIG. 4 is an exploded view of fourth embodiment of the tray assembly.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

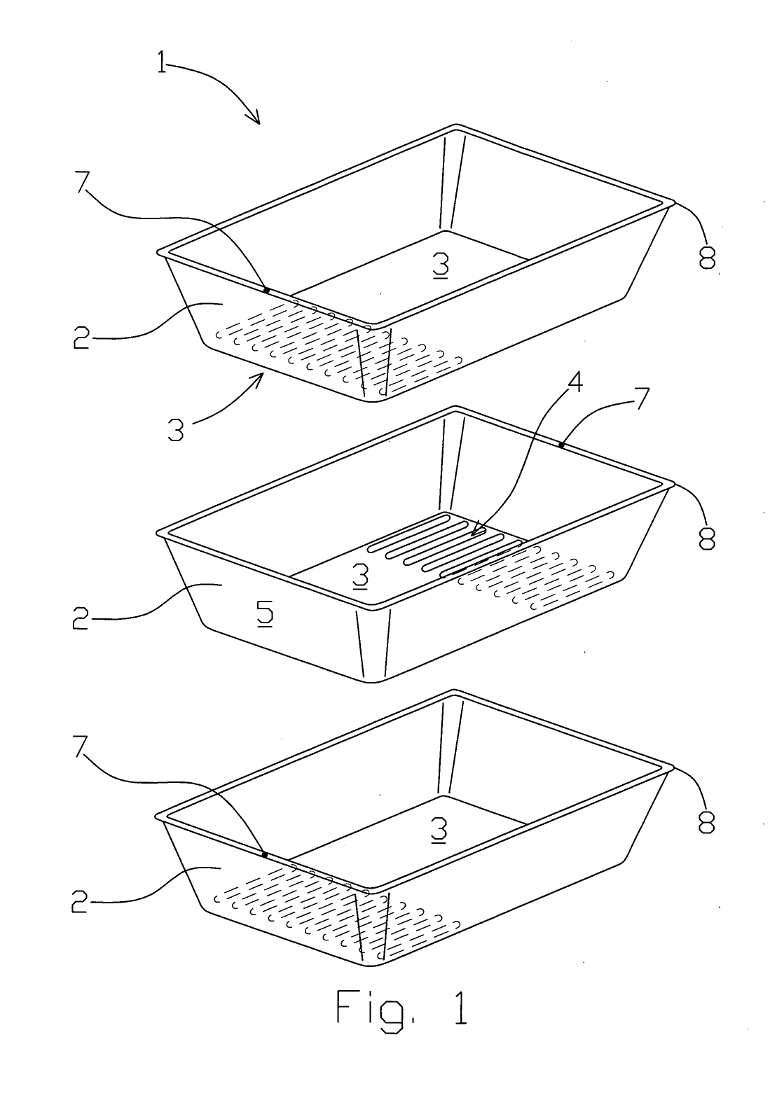

FIG. 1 is an exploded view of the tray assembly showing a minimal number of trays that are necessary to practice the sifting operation of the invention. Three trays 2, each include a plurality of elongated openings 4 which are offset to a centerline that bisects each tray into two halves such that the openings 4 extend along substantially one half of a bottom 3 of a respective tray. A curved lip 8 is provided along the open top of tray 2 to assist the user in separating the trays and include a visual indicator 7. The visual indicator 7 is provided for ensuring that the openings 4 of successive trays are alternated to ensure proper operation of the invention. During use, a user alternates the visual indicators in the stack to ensure that the openings 4 are arranged above a solid portion of the next succeeding tray. In this manner, the openings are assured to be closed. Each sidewall 5 is tapered from top to bottom to facilitate the organizing of multiple trays into a single stack. The slotted openings 4 are alternated within the stack such that a solid region of an underlying tray is arranged beneath the slotted openings of a tray above.

A clumping medium, such as clay litter, is deposited into a top of the stacked array of trays during use. An animal deposits waste matter into the clay litter. The top tray is then lifted upwards and moved back and forth to sift lumps of the pet waste from the cleaner litter. The smaller cleaner litter passes through the openings and is deposited into the second tray. The pet waste is then discarded and the top tray is placed beneath the bottom tray. The process may then be repeated as necessary to maintain a clean assembly.

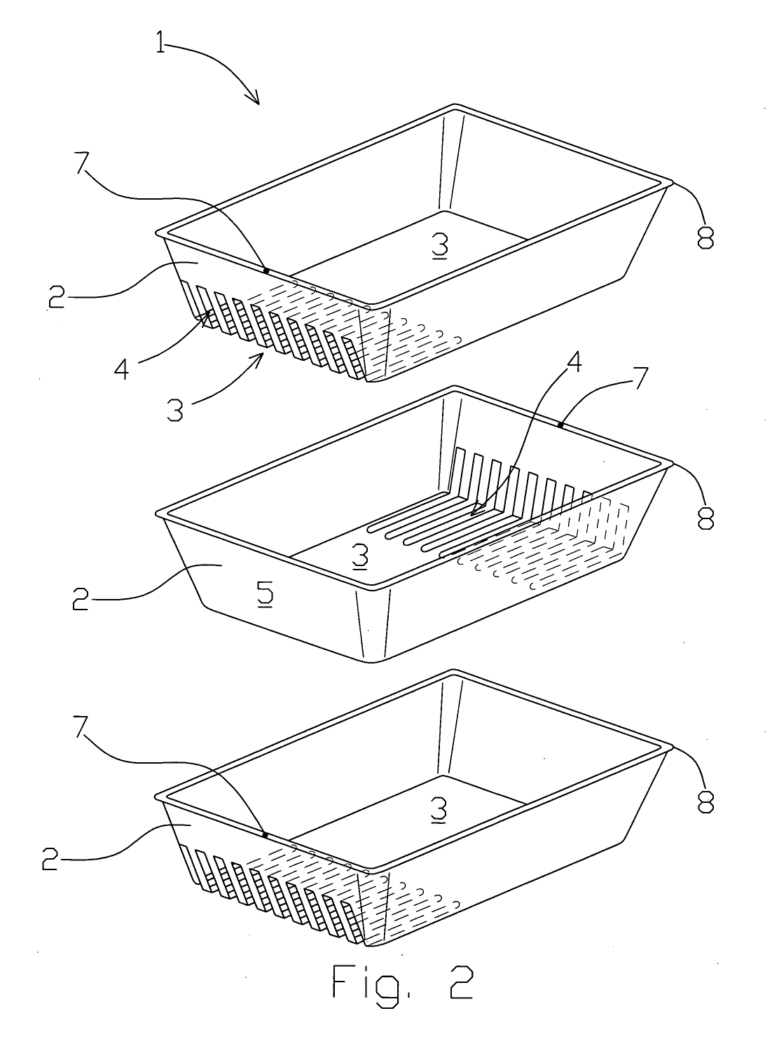

FIG. 2 is an exploded view of a second embodiment of the invention which includes offset slotted openings 4 that extend along a portion of a bottom 3 of the tray and into a sidewall 5. The openings 4 are offset to one side of a centerline that bisects the tray into two ends as shown and described above. The openings 4 extend upward substantially halfway up along one end of the sidewall 5.

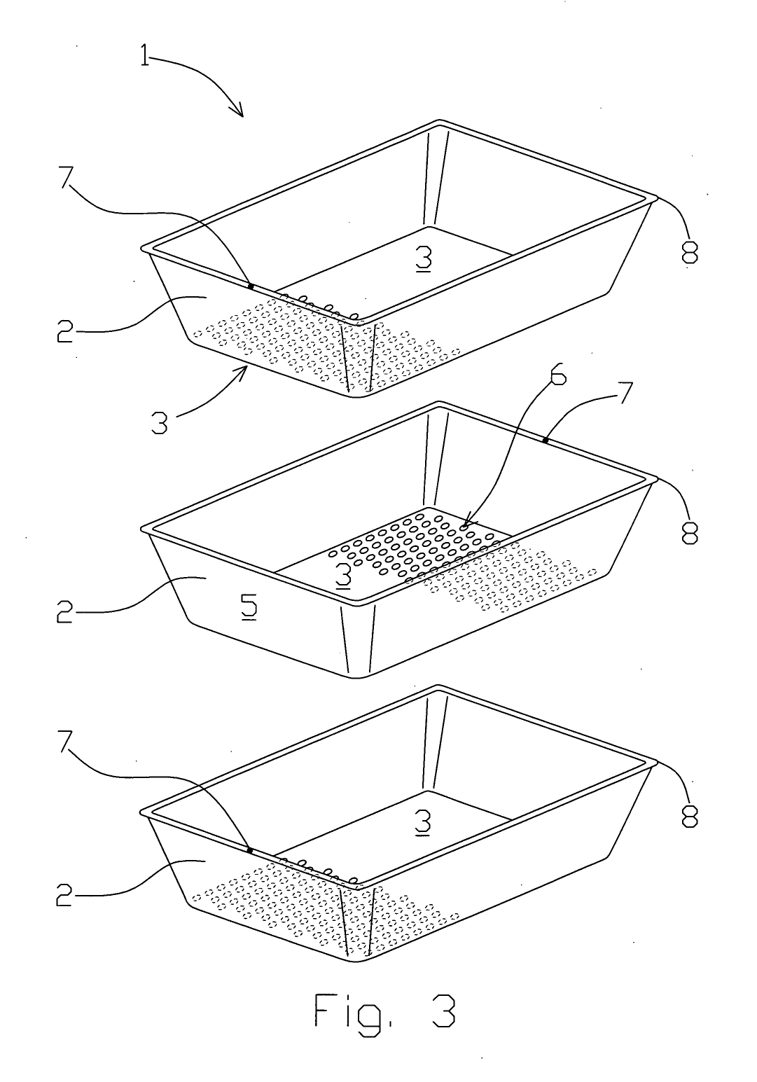

FIG. 3 is an exploded view of a third embodiment of the sifting mechanism that includes circular openings 6 that extend along a portion of the bottom 3. This embodiment is very useful as the tray may be tilted and sifted such that the clumps of pet waste are maintained in the corners formed between the sidewalls and bottom of the tray.

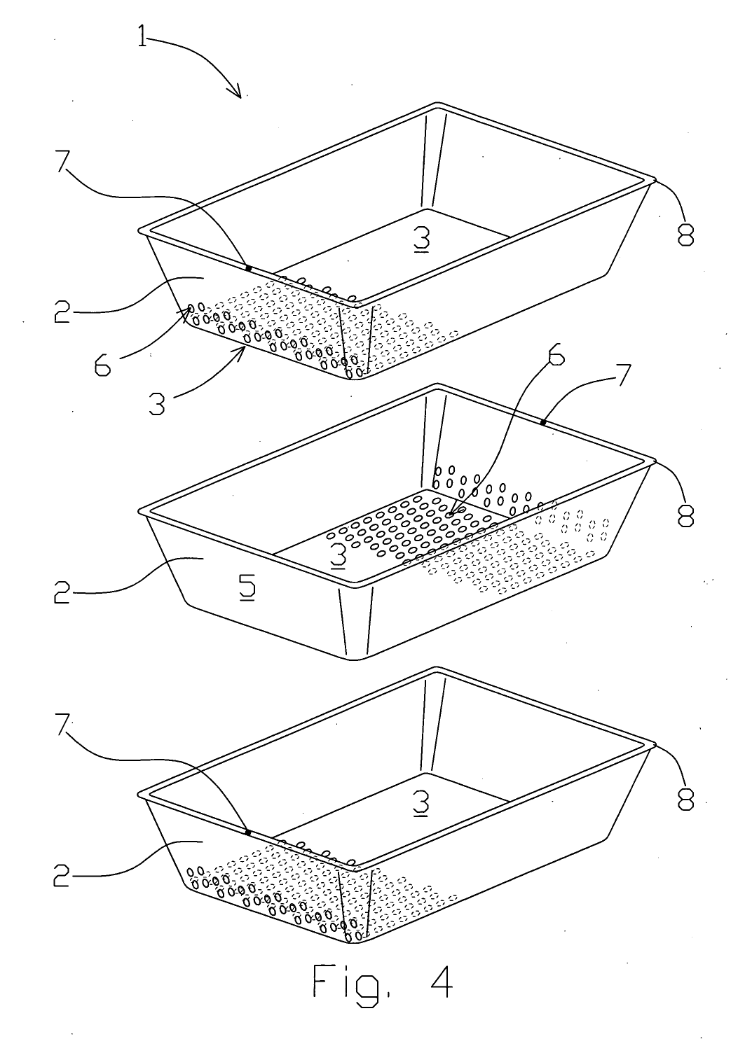

FIG. 4 is an exploded view of a fourth embodiment of the sifting mechanism that comprises circular openings that extend throughout a portion of the bottom 3 of the tray and upwards along sidewall 5.

The instant invention allows for less frequent cleaning of litter while maintaining a cleaner litter. Litter is simply deposited into the top of the stack of trays. It is very useful in animal shelters or where cats may be boarded. It is ideal for cat owners who are elderly, disabled, or who suffer from diseases that make bending or stooping over difficult. The trays may be constructed from lightweight, durable plastic material that is easy to shape. The plurality of stackable litter boxes may comprise plastic material formed in an injection molding process or blow molding techniques.

It is to be understood that the invention is not limited to the exact construction illustrated and described above, but that various changes and modifications may be made without departing from the spirit and the scope of the invention as defined in the following claims. While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A pet waste assembly comprising a plurality of stacked trays, each tray including a bottom being substantially bisected into a solid region and a porous region, an open top, and a tapered sidewall that extends from the bottom to the open top and includes a lip provided along an upper end of the tapered sidewall,
wherein said stacked trays are arranged such that a first tray is deposited onto a floor and second tray is deposited atop the first tray with the porous region from the second tray is arranged above the solid region of the bottom of the first tray and a porous region of the bottom of a third tray is arranged atop a solid portion of the second tray.

2. The pet waste assembly of claim 1 wherein said porous region of each tray comprises elongated openings.

3. The pet waste assembly of claim 1, wherein said porous region of each tray comprises elongated openings that extend from the bottom into the tapered sidewall of each tray.

4. The pet waste assembly of claim 1 wherein said porous region of each tray comprises circular openings.

5. The pet waste assembly of claim 1 wherein said porous region of each tray comprises circular openings that extends from the bottom into the tapered sidewall of each tray.

6. The pet waste assembly of claim 1 further including a visual indicator that indicates a location of the porous region.

7. An improved litter box assembly comprising three trays, each tray including a tapered sidewall, an open top, and a bottom having two halves, one half of the bottom being porous and the other half of the bottom being solid, said trays being stacked to create a stack of trays such that the porous half of each tray is arranged in contact with at least one solid half of another of the three trays and stacked.

8. The improved litter box assembly of claim 7 wherein said porous half of each bottom comprises elongated openings.

9. The improved litter box assembly of claim 7 wherein said porous half of each bottom comprises elongated openings that extend from the bottom into the tapered sidewall of each tray.

10. The improved litter box assembly of claim 7 wherein said porous half of each bottom comprises circular openings.

11. The improved litter box assembly of claim 7 wherein said porous half of each bottom comprises circular openings that extends from the bottom into the tapered sidewall of each tray.

12. The improved litter box assembly of claim 7 further including a visual indicator that indicates a location of the porous region such that the visual indicators are alternated between opposite ends of the stack of trays.
